(19) United States
(12) Patent Application Publication
(10) Pub. No.: US 2025/0368786 A1
(43) Pub. Date: Dec. 4, 2025

(54) NOVEL SARGASSUM-BASED POLYMER COMPOSITE FILAMENTS FOR 3D PRINTING AND METHOD OF MAKING THE SAME

(71) Applicants: Polytechnic University of Puerto Rico, San Juan, PR (US); Rutgers, The State University of New Jersey, New Brunswick, NJ (US)

(72) Inventors: Omar A. Movil Cabrera, Trujillo Alto, PR (US); David Salas-de la Cruz, Philadelphia, PA (US)

(21) Appl. No.: 18/878,564

(22) PCT Filed: Jun. 26, 2023
(86) PCT No.: PCT/US2023/026199

§ 371 Date: Dec. 23, 2024

Related U.S. Application Data
(60) Provisional application No. 63/355,212, filed on Jun. 24, 2022.

(51) Int. Cl. C08J 3/12; B33Y 70/10

(52) U.S. Cl. CPC C08J 3/12; B33Y 70/10; C08J 2399/00; C08J 2467/04

(57) ABSTRACT

The present disclosure includes Sargassum-based polymer composite filaments for 3D printing having (1) a higher content of algae biomass as compared with commercially available algae-based filaments, and (2) enhanced 3D printer bed adhesion and biodegradability as compared to polylactic acid (PLA) filaments.

### FIELD OF THE DISCLOSURE

The present disclosure relates generally to a novel Sargassum-based polymer composite filaments for 3D printing having (1) a higher content of algae biomass as compared with commercially available algae-based filaments, and (2) enhanced 3D printer bed adhesion and biodegradability as compared to polylactic acid (PLA) filaments.

### BACKGROUND OF THE DISCLOSURE

Every year, mats of brown algae known as “Sargassum” drift along the seashores of most Caribbean islands. Among all the existing Sargassum species, Sargassum fluitan and Sargassum natans are the two most common in the Caribbean region. In terms of compositions (% w/w) these pelagic species are rich in carbohydrates (˜57%), contrasting with microalgae which are rich in proteins (50-56%). Typically, Sargassum algae exhibit a highly branched thallus with hollow berrylike floats (pneumatocysts). In the case of Sargassum natans algae, these have long stalks with spines on the air bladder. In contrast, Sargassum fluitan algae have short stalks with wing tissue round it, but do not exhibit spines on the bladder.

The Sargasso Sea has always been considered as the principal source of these brown algae. This unique sea (the only one without a shoreline) is located in the North Atlantic Ocean between the meridians 70° and 50° W and the parallels 25° and 35° N and is formed by different circular currents that flow from east to west (North Equatorial Current) and from west to east (Gulf Stream). The temperatures of the Sargasso Sea are >17° C. all year long, which facilitates the growth of the pelagic algae in question.

It is widely known that Sargassum plays an important role in the marine ecosystem. It has been reported that more than 100 species of invertebrates, over 280 species of fish, four species of turtles, and 23 species of seabird utilize these algae as a source of food, for protection, for nesting, as a nursery, or as a means of transportation. In addition, when Sargassum loses its buoyancy, it sinks to the seafloor, providing energy in the form of carbon to fish and invertebrates in the deep sea. In the case of Sargassum algae that reach the shoreline, these also play an important role in reducing coastal erosion and enriching with nutrients the coastal soil.

Over the last few years, the volume of floating Sargassum that arrives to the Caribbean beaches has been progressively increasing. In June 2018, a team of researchers at the University of South Florida (USF) reported the record high amount of Sargassum (˜20 million tons) detected on the surface of the Atlantic Ocean from the west coast of Africa to the Gulf of Mexico. The team called this bloom as “The Great Atlantic Sargassum Belt”. More recently, in June 2021, a Sargassum bloom that essentially had the same size of the record registered in 2018 was reported.

According to the current literature, the Sargassum bloom could be attributed to a combination of the following key factors: (1) the abnormal ocean currents and winds patterns linked to the global climate change, which have facilitated the transport of Sargassum out of the Sargasso Sea, (2) the increment of fertilizer-derived nutrients in the Amazon river, as a result of the rampant agricultural practices in the Amazon rainforest, (3) the occurrence of massive Sahara dust clouds moving over the Atlantic Ocean, since these contain small traces of iron, nitrogen and phosphorus which fertilize Sargassum, and (4) the increment of the ocean temperature, since Sargassum proliferates easier in warm waters.

These unprecedented coastal Sargassum inundations have been detrimental not only to marine ecosystems but also to the human health and economy of several Caribbean coastal communities. For example, Sargassum piles on the shores poses a threat for sea turtles, since these impede beach access for nesting. In addition, the unpleasant odors caused by Sargassum decomposition, cause headaches and nauseas to humans. In terms of economic impact, Sargassum bloom has significantly affected tourist areas like Quintana Roo in Mexico, where it has been reported a reduction in hotel occupancy rates after the algae surge in 2018. Also, some reports indicate that beachfront resorts located in Cancun spent around US $200,000 in activities related to the removal and disposal of Sargassum during the same year.

In the Caribbean, Puerto Rico has also been impacted by coastal Sargassum inundations. In municipalities like Lajas, Fajardo, and Humacao, the death of fish has been associated with a significant reduction in oxygen levels in water after the vast accumulation of Sargassum, which usually takes place annually between May and June. In addition, small local business that depend on the tourism sector like kayak tour operators, beachfront restaurants and inns are being affected by the Sargassum bloom year after year.

Despite the negative impact of the brown tide described above, Sargassum has the potential of being a valuable source for multiple industries including among others, pharmaceuticals, cosmetics, fertilizers, civil construction materials, and bioplastics. Currently, several research groups are exploring the use of Sargassum as a raw material for the extraction of alginates, fucoidans and some bioactive compounds. Sargassum is also being tested as a raw material in the fabrication of biofuel, paper, bricks, shoes, complementary animal food, complementary fertilizers, biofilters, and biosorbent materials, among others.

In the search for new applications of Sargassum biomass, the present application discloses the use of these macroalgae as a filler material to fabricate polymer composite filaments for additive manufacturing (also known as 3D printing). More specifically, renewable Sargassum powder will be incorporated into polymer composite filaments for fused deposition modeling (FDM) 3D printing. These novel composite filaments will be placed in a 3D printer to fabricate different consumer goods like cell phone cases, earbud holders, and eyeglasses frames.

Among all the emerging technological fields, 3D printing is certainly one of the most promising for the future of the nation. The American Society for Testing and Materials (ASTM) defines 3D printing as a “process of joining material to make parts from 3D digital models, usually layer upon layer, unlike subtractive and formative manufacturing methods. 3D printing global market is expected to grow to almost US $51 billion in 2030, particularly because of significant changes that are predicted to occur in this industrial sector, from prototyping to the mass production of parts and accessories. In general, the main advantages of 3D printing are: (1) fast production, (2) single step manufacture, (3) complexity and design freedom, (4) complete customization of designs, (5) ease of access, (6) minimization of waste, (7) cost-effective, and (8) decentralized manufacturing.

Among all the potential applications of algae biomass, its utilization as a filler for the fabrication of 3D printing filaments is one of the most appealing. The reason is because despite 3D printing is considered as one of the key players in the fourth industrial revolution, this emerging field is already facing issues of sustainability.

In the case of the fused deposition modeling (FDM) 3D printing, this is an extrusion-based technology where melted thermoplastics are deposited layer by layer on a bed to fabricate 3D models previously created by computer. Thermoplastics such as acrylonitrile butadiene styrene (ABS), polylactic acid (PLA), nylon, and thermoplastic urethane (TPU) are the materials of choice for FDM 3D printing. Most of these materials are not biodegradable, which contributes to the global plastic pollution. Other materials like PLA, biodegrade at high rates but only under specific conditions of temperature and humidity. Over the last few years, research groups from different institutions and companies around the world have been working on the development of algae-based 3D printing filaments. One of these examples is the work performed by Dutch designers Ertic Klarenbeek and

Maartje Dros at LUMA Atelier in France. These creative designers cultivated microalgae at their laboratory, which were processed into filaments to create different 3D printed objects. Reports about their work lack information about the algae content of these filaments but considering the color that exhibit the objects that they printed, it is possible to deduce that is low.

In a similar vein, three U.S.-based companies (ALGIX, 3D Printlife, and 3D-Fuel) have been working collaboratively since 2015 on the fabrication of 3D printing filaments containing up to 20 wt % of microalgae biomass (cyanobacteria). Their process uses microalgae biomass that is collected from lakes and rivers around the world. To harvest the microalgae, they use a specialized machine in addition to standard coagulants, which allows the algae to stick together in small clumps or flocks. The fabricated filaments also contain additives to enhance their mechanical properties. Reviews of these fabricated filaments indicate that this kind of microalgae-based filaments emit unpleasant odors during the printing process. Hypothetically, this fact is most likely due to the thermal denaturation of the protein and/or decomposition of flocculants present into these filaments.

It is important to mention that despite all the potential advantages that Sargassum could offer as a raw material for polymer composite filaments (as compared to microalgae), this approach has not been explored yet. Accordingly, it would be desirable to develop Sargassum-based polymer composite filaments for 3D printing with a higher content of algae biomass that exhibits enhanced materials properties and printability as compared to commercially available algae-based filaments.

### SUMMARY OF THE DISCLOSURE

A novel Sargassum-based polymer composite filaments for 3D printing having (1) a higher content of algae biomass as compared with commercially available algae-based filaments, and (2) enhanced 3D printer bed adhesion and biodegradability as compared to polylactic acid (PLA) filaments.

### BRIEF DESCRIPTION OF THE DRAWINGS

FIG. 1 shows the Sargassum powder fabrication steps of a process for making Sargassum-based polymer composite filaments for 3D, in accordance with the principles of the present disclosure.

FIG. 2 shows the coated PLA pellets fabrication steps of a process for making Sargassum-based polymer composite filaments for 3D, in accordance with the principles of the present disclosure.

FIG. 3 shows the PLA/Sargassum composite filament fabrication steps of a process for making Sargassum-based polymer composite filaments for 3D, in accordance with the principles of the present disclosure.

FIG. 4 shows how the temperature zones change depending on the amount of Sargassum embedded into the filament.

FIGS. 5a-c show 3D printed specimens fabricated filaments having different wt % of Sargassum.

FIG. 6 shows scanning electron microscopy images of dried Sargassum.

FIG. 7 shows scanning electron microscopy images of dried Sargassum after grinding.

FIG. 8 shows scanning electron microscopy images of dried Sargassum after grinding and ball milling.

FIG. 9a-b show scanning electron microscopy images of dried Sargassum after grinding and ball milling at a higher magnification.

FIG. 10a-b show a thermogravimetry analysis of dried Sargassum, grinded powder and ball milling powder.

FIG. 11 shows images of fabricated PLA/Sargassum filaments at different wt %.

FIG. 12a-b show a thermogravimetry analysis of the fabricated filaments having different wt % of Sargassum.

FIG. 13 shows scanning electron microscopy images for 3D printed specimens having different wt % of Sargassumpowder contents.

FIG. 14 shows scanning electron microscopy images for 3D printed specimens having different wt % of Sargassumpowder contents.

FIG. 15a shows yield strength as a function of Sargassumcontent into the specimens.

FIG. 15b shows elastic modulus as a function of Sargassumcontent into the specimens.

FIG. 16 shows images of burial tests to determine the degradation of the specimens with Sargassumcontent.

FIG. 17 shows weight loss as a function of the Sargassumcontent into the specimen at different continuous degradation times.

### DETAILED DESCRIPTION OF THE DISCLOSURE

The use of Sargassum as a filler material offers a lot of potential advantages. For example, the fabrication of Sargassum-based composite filaments does not require the use of additives (e.g., plasticizers) to guarantee their mechanical stability. This fact is supported by the fact that Sargassum is rich in alginates and the function of these constituents is to give strength and flexibility to the algal tissue. Brittleness of the filaments was only observed at filler contents higher than 20 wt %. Another advantage is that alginates can also act as a glue to enhance the adhesion between the printed layers, which could result in 3D printed structures with enhanced mechanical properties. To support this statement, it is worth mentioning that during the proof-of-concept trial it was observed that the structures fabricated from Sargassum-based polymer composite filaments adhere better to the printer bed as compared to those fabricated from commercial PLA. Another advantage of using Sargassumbiomass as a filler is the fact that this possesses a high concentration of functional groups. Some of these functional groups contain oxygen and carbon like the carboxyl groups in the alginic acid. In addition, some nitrogen-containing functional groups (amino/amido groups) and sulfur-containing functionalities (sulfonate and thiol) have also been found in Sargassum. These functional groups can be used to chemically modify the surface of the particles to enhance the compatibility between the hydrophobic polymer matrix (like PLA) and the Sargassum-based fillers. The presence of some functional groups in Sargassum can also promote the biodegradation of the Sargassum-based polymer composite filaments. According to previous reports, nitrogen-containing functional groups present in Sargassum create bonds with the carbonyl groups of PLA forming amide groups.

Conveniently, amides increase the formation of biofilms onto the polymer composite surface, which could result in an accelerated decomposition of the material.

The subject disclosure relates to a novel Sargassum-based polymer composite filaments for 3D printing having a higher content of algae biomass, and exhibiting enhanced materials properties and printability as compared to commercially available algae-based filaments. The method for making the novel Sargassum-based polymer composite filaments is subdivided into two parts: 1) a Sargassum powder fabrication process; and 2) a PLA/Sargassum composite fabrication process.

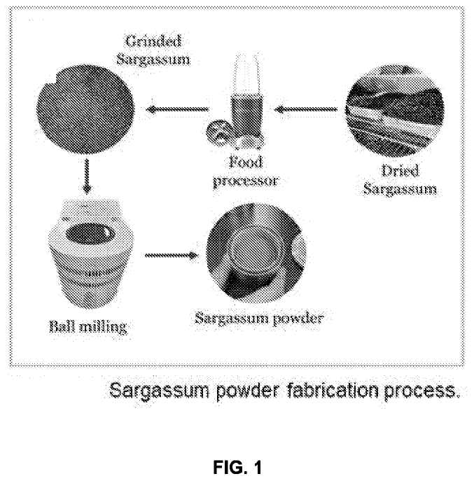

The methodology implemented for the fabrication of the Sargassum powder comprises five (5) steps, as shown in FIG. 1. The first step of the fabrication process begins with the collection of Sargassum from local beaches. The collected Sargassum is then washed with water to remove any sand, organisms, debris, and/or heavy metals. The third step involves drying the Sargassum by placing it in an oven at a temperature of 120° C. for 24 hours. After drying in the oven for 24 hours, the Sargassum is then inserted in a food processor or similar device to obtain Sargassum micropowder. To achieve a smaller surface area for the Sargassum micropowder, a specialized equipment is used. The equipment in question is a ball mill, as shown in FIG. 1. The ball mill is an equipment that has four containers that move in a manner similar to the planetary movement. Inside these containers, metal spheres are inserted to pulverize the sample. Each container is filled with 20 g of the Sargassum, 9 large spheres, and 62 small spheres. As such, the next step of the fabrication process involves pulverizing the Sargassum micropowder in the ball mill to obtain a Sargassum nanopowder (see FIG. 1). Based on the results obtained, in which Sargassum was crushed via ball milling. In terms of printability, it is expected that the incorporation of Sargassum nanofillers into the filaments will help prevent nozzle clogging issues during the printing process. After one hour of ball milling, it is possible to obtain Sargassum powder with finer particles in the range of 50 nm and 1.29 μm.

The advantages of using nanofillers in polymer composites is well documented in the literature. In general, nanofiller contents in the range between 3 wt %-5 wt % achieve the same reinforcement as 20 wt %-30 wt % of microfillers. A basic explanation for this is that nanofillers enable potentially higher interfacial interactions and hence, higher elastic modulus. However, at higher nanofiller content, composite properties decrease indicating difficulties in dispersing the fillers. Since current literature lack of information about the use of Sargassum powders as a filler in polymer composite filaments, the results obtained here will offer valuable information to the 3D printing scientific community.

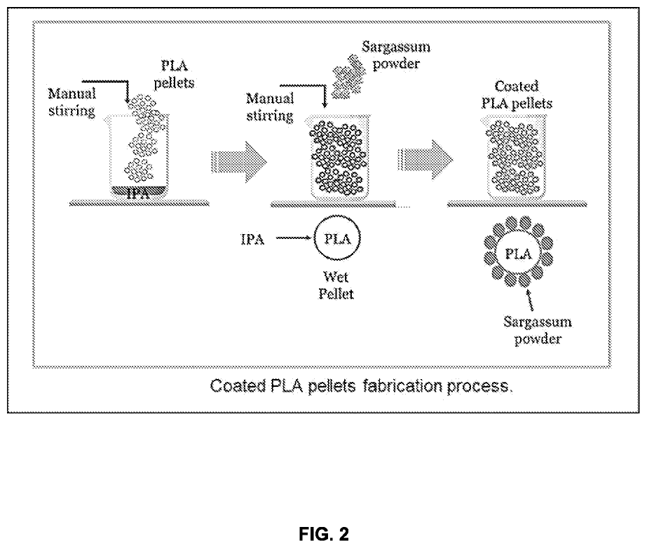

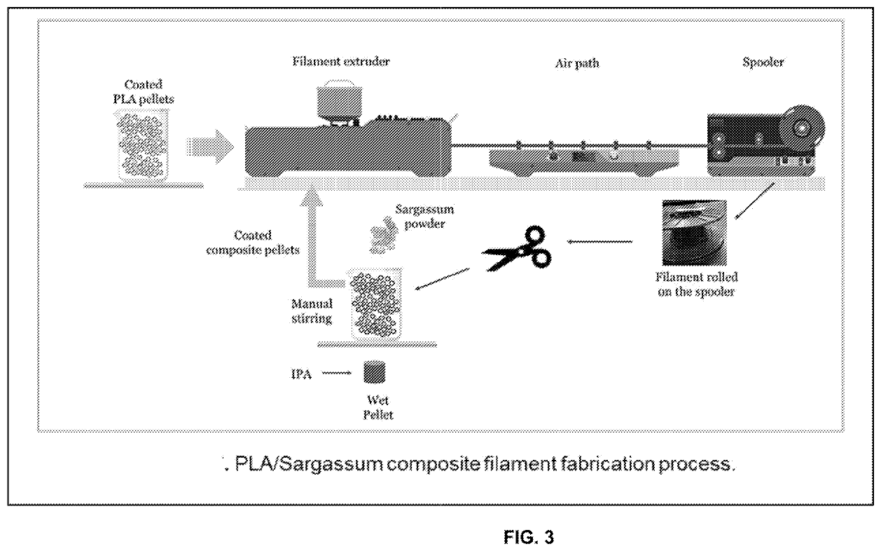

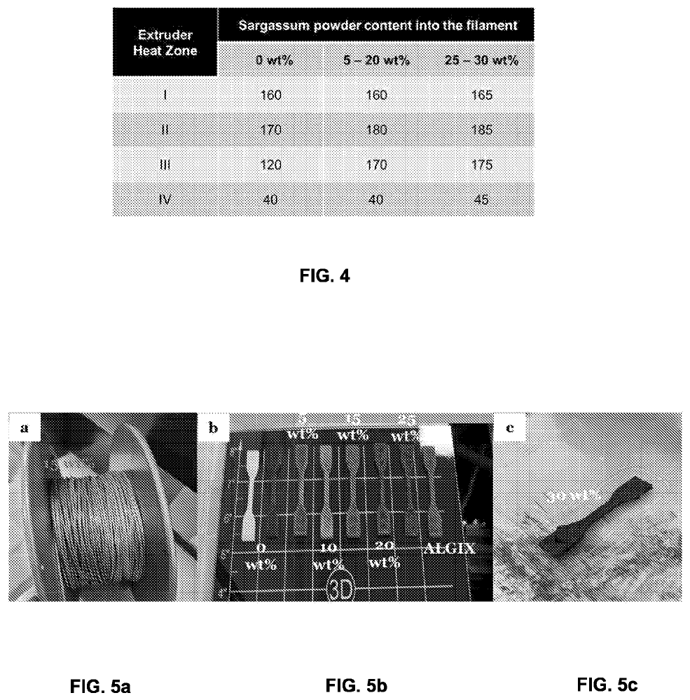

The PLA/Sargassum composite fabrication part of the process requires the creation of a coating of Sargassum powder onto the surface of the PLA pellets using isopropyl alcohol as a glue. The total amount of Sargassum powder to be used is divided into three (3) equal parts to facilitate the manipulation of the powder. The amount of PLA used is 150 g, while the amount of Sargassumpowder depends on the desired biomass content (0 wt-30 wt %). The filament fabrication process is performed as follows: Firstly, PLA pellets are wetted with isopropyl alcohol using an atomizer (˜10-15 mL). Then, one of the 3 parts of Sargassum powder is added to cover the surface of the pellets. The aforementioned process can be observed in FIG. 2. The PLA pellets covered with Sargassum are then fed into an extruder called Filabot® which is a specialized equipment used for the fabrication of the filaments, as shown in FIG. 3. The Filabot® has 4 heating zones that can be modified to enhance the extrusion process and quality of the filament (See FIG. 3). Then, a second part of the Sargassumpowder is used in the first reprocessing cycle, while the remaining part is used in the second and final reprocessing cycle. Each cycle is performed under the same conditions as follows: The obtained composite filament is cut into small pieces and one part of the Sargassum powder is added after wetting the pellets with isopropyl alcohol. The pellets covered with Sargassum powder are then fed to the Filabot® extrusion machine to obtain a filament. This process is repeated one more time to consume the total amount of Sargassum powder. It should be noted that the temperature in the extruder heat zones changes depending on the amount of Sargassum embedded into the filament, as shown in FIG. 4. The presence of Sargassum powder has an important effect on the thermal and flowability properties of the fabricated composite material. As shown in FIG. 4, it is possible to observe that the extruder heat zone I, II, and III increases as the Sargassum content increases.

In another embodiment, PLA pellets are coated with suitable amounts of powder (0 wt %-30 wt %) via manual mixing using a small volume of isopropyl alcohol (IPA), which acts as a glue. It is expected that this semi-dry coating process will promote a homogeneous dispersion of the fillers into the polymer matrix without using large amounts of solvents (like in solvent casting) nor energy-intensive methods like melt blending. Since a previous work developed by the inventor and his team indicates that the introduction of free powder into the extrusion machine (Filabot®) causes some flowability issues, it is expected that the attachment of the Sargassum powder onto the surface of the PLA pellets will help prevent the Filabot® extrusion machine from clogging. After the “coating” step, the modified pellets are fed into an extruder to fabricate the filaments. The extrusion temperatures and spooling speed are controlled to obtain the required filament's thickness and quality. Finally, the filaments are placed in FDM 3D printers to fabricate different specimens, as shown in FIG. 5. The resulting filaments can be used for the fabrication of consumer goods like cell phone cases, earbud holders, and eyeglasses frames using Sargassum-based 3D printing filament.

It should be noted that the PLA polymer matrix can be replaced by other thermoplastics including: Acrylonitrile Butadiene Styrene (ABS); Polyamides (Nylon); Polycarbonate (PC); Polyvinyl Alcohol (PVA); High-Impact Polystyrene (HIPS); High-Density Polyethylene (HDPE); Polyhydroxyalkanoates (PHA); Polybutylene succinate (PBS); Polycaprolactone (PCL). Moreover, to enhance the ductility of these filaments it is possible to use bio-based plasticizers such as: 1) Citrates Esters, which are the tetraesters resulting from the reaction of one mole of citric acid with three moles of alcohol. Citric acid's lone hydroxyl group is acetylated; or 2) Bio-based Plasticizers, which are based on epoxidized soybean oil (ESBO), epoxidized linseed oil (ELO), castor oil, palm oil, other vegetable oils, starches, sugars (including isosorbide esters), etc.

The use of Sargassum as a filler material offers a lot of potential advantages. For example, the fabrication of Sargassum-based composite filaments does not require the use of additives (e.g., plasticizers) to guarantee their mechanical stability. This is supported by the fact that Sargassum is rich in alginates and the function of these constituents is to give strength and flexibility to the algal tissue. Alginates can also act as a glue to enhance the adhesion between the printed layers, which could result in 3D printed structures with enhanced mechanical properties. It is worth mentioning that proof-of-concept trials have shown that the structures fabricated from Sargassum-based 3D printing filament adhere better to the printer bed as compared to those fabricated from commercial PLA. In line with this fact, it is expected that the adhesion properties of these novel filaments will be enhanced at higher Sargassum powder contents. Another potential advantage of using Sargassum biomass as a filler is the fact that this possesses a high concentration of functional groups. Some of these functional groups contain oxygen and carbon like the carboxyl groups in the alginic acid. In addition, some nitrogen-containing functional groups (amino/amido groups) and sulfur-containing functionalities (sulfonate and thiol) have also been found in Sargassum. The assumption here is that most of these functional groups create bonds with the PLA matrix, which could result in a composite material with enhanced mechanical properties. The presence of some functional groups in Sargassumcan also promote the biodegradation of the Sargassum-based 3D printing filament. According to previous reports, nitrogen-containing functional groups present in Sargassum create bonds with the carbonyl groups of PLA forming amide groups. Conveniently, amides increase the formation of biofilms onto the polymer composite surface, which could result in an accelerated decomposition of the material.

Another advantage is that Sargassum harvesting does not require the use of flocculants, which could help reduce the costs associated with the algae biomass processing. This is a competitive advantage of Sargassum when used as feedstock, as compared to microalgae harvested from rivers and lakes.

Following the disclosed process for the production of Sargassum-based polymer composite filaments for 3D printing, it was possible to fabricate mechanically stable filaments with the following characteristics: filler particle sizes between 50-1.29 μm, filler content ranging between ≥30 wt %, filament thickness ranging between 1.39 and 2.05 mm, elastic modulus ranging between 375 and 648 MPa, and yield strength ranging between 14 and 33 MPa. It was possible to fabricate Sargassum-based 3D printing filament with Sargassum powder content up to 30 wt %. FIG. 2 shows specimens fabricated with different filaments. The first two specimens (from left to right) were fabricated from fabricated PLA and Commercial PLA filaments. The rest of specimens were 3D printed using Sargassum-based 3D printing filament with Sargassum content of 5 wt %, 10 wt %, 15 wt %, 20 wt %, 25 wt % and 30 wt % (See FIGS. 5a-c).

Moreover, by following the disclosed process, consumer goods (e.g., cell phone cases, earbud holders, and eyeglasses frames) were successfully 3D printed using filaments having filler contents ≥20 wt % without having issues such as nozzle clogging or filament breaking during a print. The printing process was performed on a cheap 3D printer under de following conditions: (1) nozzles with sizes of 1 mm set at 220° C., (2) plate temperature set at 60° C., and (3) printing speed of 30 mm/s with a line pattern.

Unpleasant odors were not detected by the team during the printing process. All the 3D printed specimens made from the disclosed Sargassum-based 3D printing filament exhibited better adhesion to the printer bed than PLA and ALGA™ filaments. Adhesion was evaluated qualitatively. Burial test results suggest that the weight loss (wt %) of the fabricated specimens increases ˜4.5 times as the biomass content increased from 0 to 30 wt % (after 120 days). Results are presented in FIG. 18.

In sum, the disclosed process for producing Sargassum-based polymer composite filaments for 3D printing having a higher content of algae biomass can be subdivided into two (2) main steps (i) fabrication and characterization of Sargassum powder; (ii) fabrication and characterization of Sargassum-based filaments. The resulting filaments can then be used for 3D printing of specimens and consumer goods. Below is a summary of the Sargassum-based filament fabrication process; as well as a description of the characteristics of the aforementioned filaments:

### i. Fabrication and Characterization of Sargassum Powder

After collecting fresh Sargassum from the beach, the Sargassum is rinsed with deionized (DI) water three times. Next, the wet Sargassum is dried in an oven at 100° C. for 24 hours. Subsequently, the dried biomass is grinded in a food processor (Nutribullet®) and then optionally sieved using a U.S.A standard testing sieve to obtain Sargassum powder with particles sizes<500 μm. Afterwards, 20 grams of Sargassum powder and 100 g of 6 mm-diameter stainless-steel balls is added to a 100-mL stainless steel jar. Once filled and sealed, the jar is placed in a PBM-04 ball milling machine (Micromolding Solutions Inc.) at 600 rpm for one hour. As mentioned above, the target is to obtain Sargassum particle with sizes ranging between 50 nm-1.29 μm. After each step, the particle size and morphology of the Sargassum powder is evaluated via optical microscopy, atomic force microscopy (AFM), scanning electron microscopy (SEM) and transmission electron microscopy (TEM). A Nikon Ni-U Upright microscope equipped with a high-resolution digital camera and a z-AFM from NanoMagnetics Instruments Ltd., can be used to perform the analysis in question. In addition, a Perkin-Elmer Two Fourier Transform Infrared (FTIR) spectrometer is used to detect changes in the chemical structure of Sargassum after each step.

### ii. Fabrication and Characterization of Sargassum-Based Filaments

The first step is the PLA pellet wetting process. In this case, 150 grams of PLA pellets are added to a beaker containing a very small volume of IPA. The pellets are then stirred to facilitate the wetting process. Then, a suitable amount of Sargassum is divided in three equal parts and one of them will be added slowly to the beaker (under stirring) to create a powder coating onto the surface of each pellet. The suitable amount will depend on the percentage by weight of Sargassum filaments desired. The amounts of powder to be added are changed to produce filaments with 5%, 10%, 15%, 20%, 25% and 30% Sargassum. All of these percentages are by weight. For example, for filaments at 5% by weight (5 wt %), 150 grams of PLA and 7.894 grams of Sargassum powder are used. Next, the modified pellets are dried in an oven at 80° C. for two hours. Importantly, the amount of Sargassum powder to be used will be modified to obtain composite materials with filler contents ranging between 0 wt %-30 wt %.

After completing the coating step, the pellets are fed into the hopper of a Filabot EX6 filament extruder to obtain the filaments. The extruder should be connected to a Filabot air path to cool down the filaments before being rolled in a spooler. The speed of the Filabot screw and spooler will be controlled to achieve a filament thickness near to 1.75 mm. The thickness will be measured continuously using an in-line Filameasure® device equipped with a Mitutoyo® digital indicator. Then, a second part of the Sargassum powder is used in the first reprocessing cycle, while the remaining part is used in the second and final reprocessing cycle. Each cycle is performed under the same conditions as follows: The obtained composite filament is cut into small pieces and one part of the Sargassum powder is added after wetting the pellets with isopropyl alcohol. The pellets covered with Sargassum powder are then fed to the Filabot® to obtain a filament. This process is repeated one more time to consume the total amount of Sargassum powder.

Unlike other extruders, the Filabot EX6 filament extruder is equipped with a multizone (i.e., zones I, II, III, and IV) temperature controller to allow the users to set the temperatures of the heating chamber, which is divided into four zones. The extruder hopper (inlet) is located in zone I, while most of the extruder screw is located in zones II and III. In the case of the extruder nozzle (outlet), this is located in zone IV (see FIG. 1, part b). To fabricate the filaments the temperatures of the zones I, II, III, and IV, will be set according to Table shown in FIG. 4. It is very likely that these temperatures are modified since the rheological behavior of these composite materials could change significantly as the content of Sargassum increases.

The materials characterization of the filaments is performed using different techniques. For example, the microstructure and quality of the filaments will be performed via optical microscopy, SEM and TEM. Special attention will be given to the filler dispersion and the presence of flaws (e.g., voids, cracks, etc.). In the case of the mechanical properties of the fabricated filaments, these will be evaluated via tensile test using an eXpert 7601 1 kN single column universal electromechanical testing system from ADMET Inc. Pieces of filaments will be used as the samples. Mechanical properties such as elastic modulus, tensile elongation, and tensile strength at yield, will be calculated from the stress-strain curves.

### iii. 3D Printing of Specimens and Consumer Goods

As previously noted, the resulting filaments can then be used for 3D printing of specimens and consumer goods. Specimens and consumer goods models (cell phone cases, earbud holders, and eyeglasses frames) can be designed using TinkerCADR or Solidworks® software. Then, the computer-generated files will be converted into 3D printable files using CURA® software. Next, these models will be 3D printed on a Creality® Ender 3Pro machine equipped with a glass bed. The printing condition to be used are: (1) nozzles with sizes of 1 mm set at 220° C., (2) plate temperature set at 60° C., and (3) printing speed of 30 mm/s with a line pattern.

### iv. Characterization Technics: TGA, SEM, Tensile Test, and Burial Test

The characterization techniques implemented were thermogravimetry analysis (TGA), scanning electron microscope (SEM), tensile test, and burial test. Thermogravimetry analysis (TGA) is a characterization technique that consists of the controlled heating of a sample over time. As the sample is being heated at a constant rate the weight of the sample is constantly measured. The obtained data is then plotted as weight loss versus temperature. This characterization technique provides information on the thermal stability of the sample and its rate of decomposition. The samples used in this application were the Sargassum powders and the fabricated filaments. TGA experiments were performed on a SDT Q600 T.A. Instruments thermogravimetric analyzer operating with constant nitrogen flow. The TGA scans were performed from room temperature to 600° C. at a heating rate of 5° C./min.

In the case of Scanning Electron Microscopy (SEM) technique, the equipment possesses a high energy electron beam projected onto the sample. The sample then deflects these electrons that are then perceived by electron detectors. The result is a highly magnified and high-resolution images of the sample. The samples analyzed were the (1) dried Sargassum, (2) dried Sargassum powder obtained after grinding, (3) dried Sargassum powder obtained after grinding+ball milling, and (4) 3D printing specimens (cross-sectional views of the tensile fractures, top views, and lateral views for each sample).

The tensile test is a characterization technique used to determine different mechanical properties of engineering materials. During the test, the machine slowly increments the tensile force applied to the samples (placed between the grips) and measures the deformation experienced by them. Using the obtained data, it is possible to construct the stress-strain curve, which provides relevant information such as tensile strength, yield strength, and elastic modulus.

For this application, the samples of interest were the 3D printed dog-bone-shaped specimens having different amounts of Sargassum biomass (0-30 wt %). Each experiment was repeated 4 times to average the results. The equipment used for the tests was the ADMET tensile tester following a modified ASTM D638-14 standard.

Burial tests were conducted to determine the biodegradability of the 3D printed materials. In this case, a series of coin-shaped specimens were 3D printed, dried, and weighted before burying them in vases (placed outdoors) containing a suitable amount of homemade compost. 500 ml of water were added onto the surface of each vase weekly to maintain the compost wet. Samples were removed from the compost after 30, 60, 90 and 120 days. After cleaning and drying the samples, these were weighted to calculate the weight losses %.

### v. Sargassum Powder Fabrication & Characterization

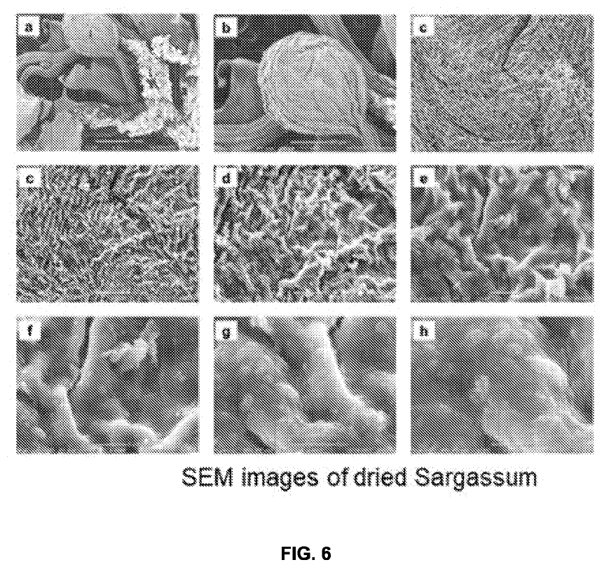

FIG. 6 shows some images of the dried Sargassum before the grinding process. FIG. 6b-h corresponds to magnifications of zone 1, labeled in FIG. 6a. Although untreated samples had been washed and dried, a complete and compact structure was observed before the grinding process (FIG. 6a-b). In fact, the pictures in question present a complete bladder. These spherical/ellipsoidal structures are typical of Sargassum fluitans and Sargassum natans anatomy and are located close to the leaves. They serve to keep the algae floating on the surface of the water and receive more light for photosynthesis. Also, the surface of the brown algae appeared to be shrunken (FIG. 6c-h), which may be attributed to the loss of a high amount of water during the drying process. The images also suggest that the algae walls possess some round structures with sizes<500 nm.

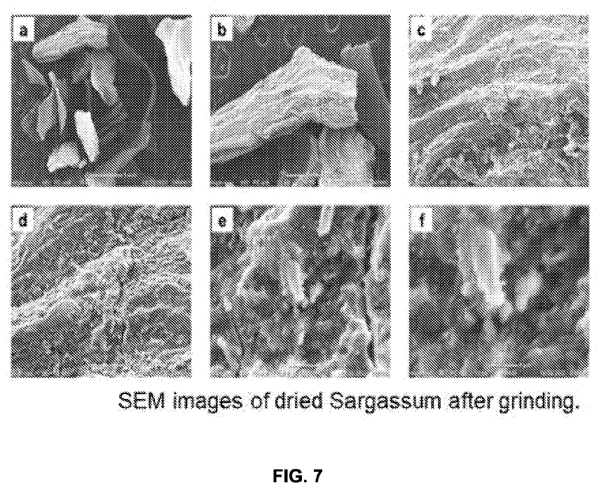

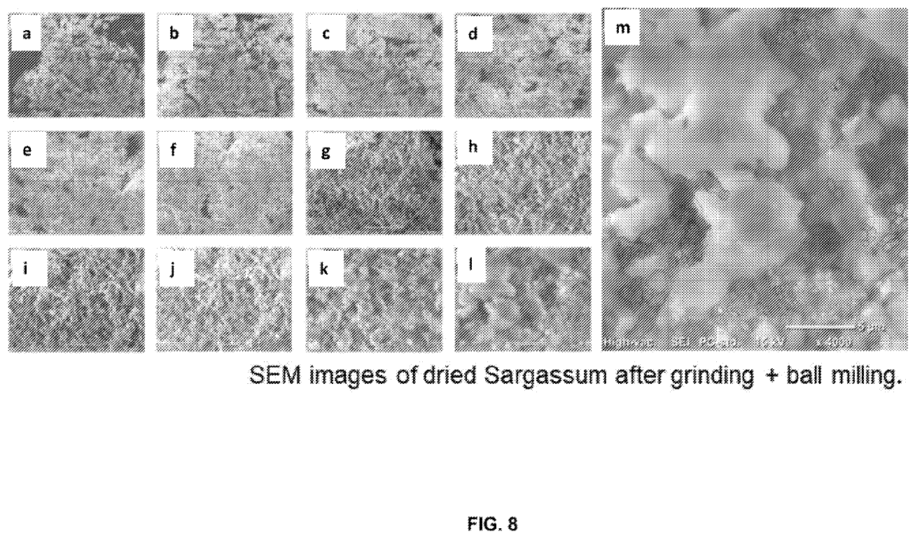

Unlike the untreated samples, images a-b in FIG. 7 indicate that the grinded (Nutribullet®) samples are composed of particles with millimetric sizes (1-2 mm). The images at higher magnification show formation of cracks and the presence of particles. The cracks are formed before the disintegration of the whole biomass in small pieces, as a result of the stress applied to the biomass during the grinding process. In the case of the Sargassum treated using a Nutribullet® and subsequently via ball milling, the sample resulted in a fine powder having a broad variety of particles from micrometric to nanometric sizes as shown in FIG. 8 The images indicate that the millimetric chunks observed in FIG. 8 were disintegrated during the ball milling process, since only micrometric particles can be observed in the images. At higher magnification (×4000) it is possible to observe particles with sizes ranging between 300-400 nm. This method opens up new opportunities to create renewable nanomaterials from Sargassum using a simple and environmentally friendly method.

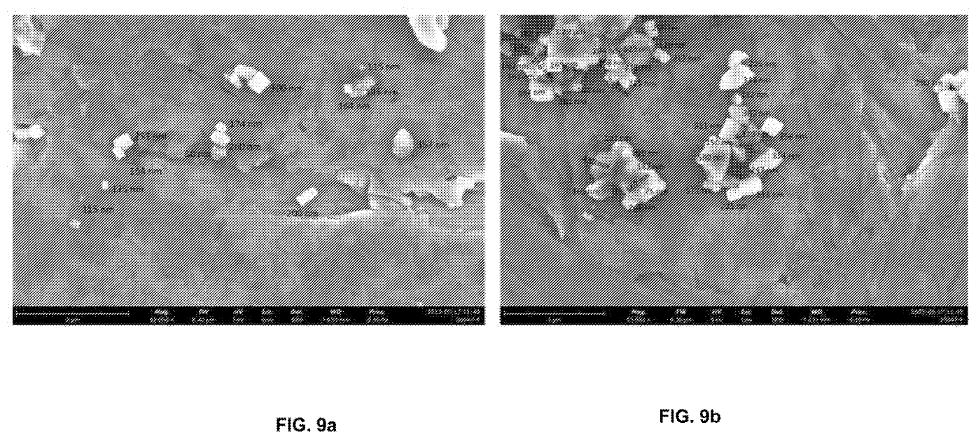

In addition, FIG. 8 also shows zones that possess large amounts of particles with sizes ranging between 500 to 300 nm. Some of these particles are spherical but some of these look-like rods. It is expected that reduction in filler size help reduce formation of large voids into the PLA polymer matrix. SEM images using a microscope with higher resolution are presented in FIGS. 9a and 9b below. The image corresponds to a sample of grinded Sargassum after being ball milled for one hour. The image shows a broad particle size range (between 50 nm and 1.29 μm), indicating that it was possible to obtain fine and nano structures from the whole Sargassum biomass via ball milling. These results also suggest that it will be necessary to increase the ball milling time to obtain a narrow particle size distribution, especially at nanometric scale.

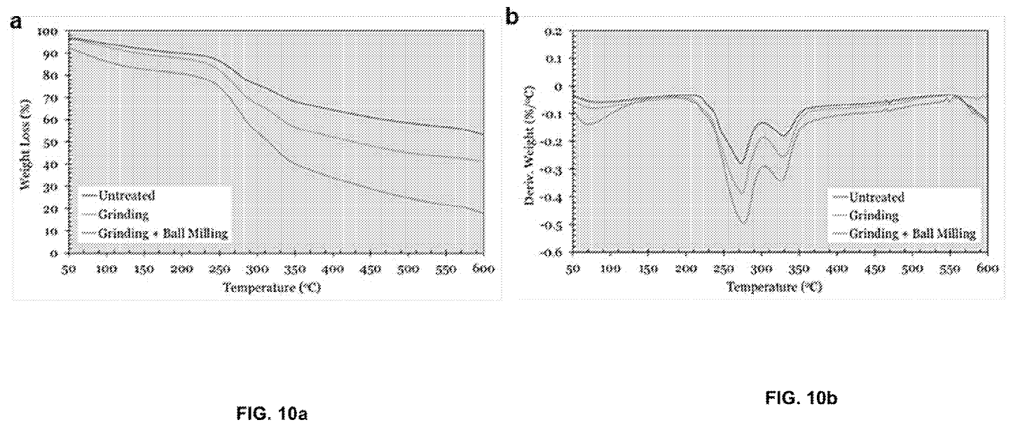

In addition to the SEM analysis, the Sargassum powder samples were also analyzed via TGA, to evaluate the thermal behavior of the powders. FIG. 10a presents the weight loss % as a function of the temperature for the dried biomass without treatments, grinded Sargassum, and grinded+ball milled Sargassum. In this case, the samples experienced three main loss steps. The first one is related to the evaporation of unbound and bound water from the algae (50-200° C.) the second step is related to the decomposition of organic groups present in the algae (200-350° C.). This reduction of weight is related to the decomposition of cellulose and hemicellulose. Finally, the third stage (350 to 600° C.), is related to the degradation of high molecular weight components like polysaccharides, proteins, and lignin. Dried Sargassum, grinded Sargassum and grinded+ball milled Sargassum exhibited char residue of 52%, 42%, and 22%, respectively.

Despite the three samples present a similar trend, the thermal degradation of grinded+ball milled Sargassum is more significant as compared to the other two samples, which suggests that the thermal stability of Sargassum significantly decreases as the biomass particle size is reduced. This is probably because a large surface area and a high density of functionalities on the surface, facilitate the thermal decomposition of Sargassum. It is widely known that as the particle size of solids decreases, their surface area increases. In our particular case, it is believed that the amount of exposed functional groups on the Sargassum's surface increases with the surface area, which results in an easier degradation of these moieties. This is the main reason why grinded+ball milled Sargassum powder exhibits a significant loss of mass at temperatures between 300° C. and 600° C. In contrast, results of the derivative weight (see FIG. 10b) indicate that the temperature for the maximum weight loss rate is not affected by the processes applied to the Sargassum biomass.

### vi. Fabricated Filaments & Specimens

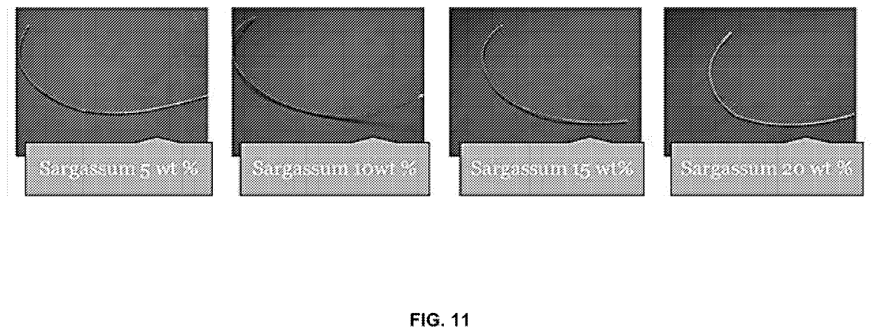

The inventor and its team have been working on the fabrication of filaments with Sargassum powder contents between 0 wt % and 30 wt % and some pieces of the filaments are shown in FIG. 11. The inventor and its team were also able to fabricate 150 grams of a filament containing 30 wt % of Sargassum powder (no presented here) without using any additive. This fact represents a breakthrough, since the commercial material (used for comparative purposes and called ALGIX, only possesses a 20 wt % of microalgae-derived biomass and contains some additives.

As expected, the presence of Sargassum powder has an important effect on the thermal and flowability properties of the fabricated composite material. In FIG. 4, it is possible to observe that the extruder heat zone I, II, and Ill increases as the Sargassum content increases. The team has been able to print with filaments containing up to 30 wt % of Sargassum biomass FIG. 5c shows examples of the dog bone-shaped specimens fabricated with the novel filaments.

FIG. 5a corresponds to 150 grams of the fabricated filament having a biomass filler content of 15 wt %. As observed, the filament is not brittle since is possible to roll it up on the spooler. FIG. 5b corresponds to fabricated dog bone-shaped specimens, which will be used in the tensile tests to measure the mechanical properties of the materials. The first to specimens corresponds to 3D printed bones fabricated from pure PLA filament created. at the laboratory (white) and commercial PLA filament (black). The rest of brown samples correspond to specimens printed from filaments containing 5, 10, 15, 20 and 25 wt % of Sargassum. The team was able to 3D print specimens containing 30 wt % of Sargassum powder and the sample is depicted in FIG. 5c.

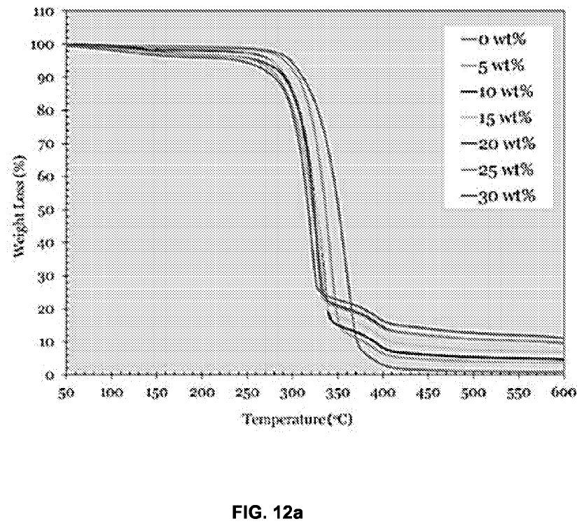

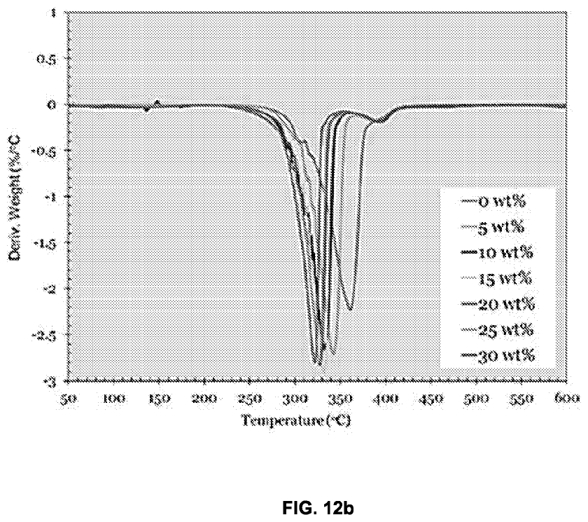

The team has also been working on the characterization (via TGA) of the fabricated filaments, specifically to determine their thermal properties. FIG. 12a corresponds to the results of the TGA experiments for the fabricated filaments at different wt % of Sargassum. As expected, the weight loss % of the fabricated filaments (when is analyzed in the range between 50-350° C.), increases with the wt % of Sargassum embedded into the PLA polymer matrix. This is because the hydrophilic character that Sargassum biomass gives to the composite (more water uptake capacity), in addition to the high density of organic functionalities present into the algae-based fillers. However, at temperatures higher than 350° C., all the fabricated polymer composite filaments exhibited a higher stability than the PLA filament. It is believed that the high amount of high molecular weight components like polysaccharides, proteins, and lignin, help to stabilize the PLA/Sargassum composites at high temperatures. Results of the derivative weight in FIG. 12b also indicate that the temperature for the maximum weight loss rate also decreases significantly with the content of Sargassum in the sample.

### vii. Microstructural Characterization of Fabricated Specimens

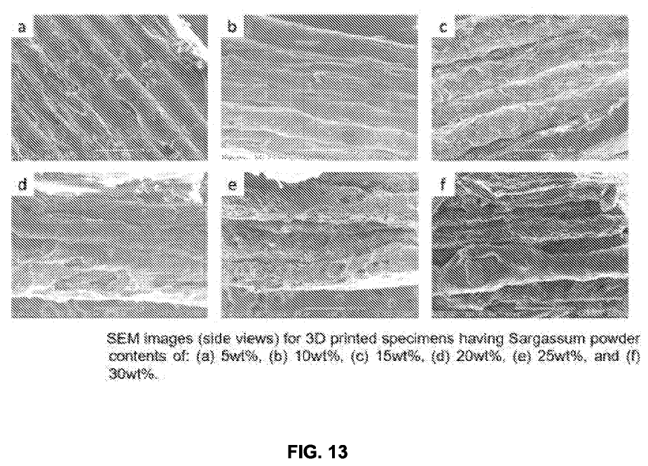

FIG. 13 presents a variety of side-view images (captured via SEM) of 3D printed specimens having Sargassum contents from 5 wt % to 30 wt %. At low biomass contents (up to 10 wt %), the specimens exhibit a well-organized layered structure with layer thicknesses ranging between 300 to 500 microns. Also, the surface of the layers looks smooth as compared to the rest of samples. As the Sargassum content increases (from 15 wt % to 30 wt %), the specimens exhibit a poorly organized layered structure. In contrast, both the surface roughness and number of defects increase with the biomass content. It is most likely that the inconsistency in layer's thickness at high Sargassum contents is a direct effect of the observed variability in the filament thickness. In addition, air gaps between the layers are observed more clearly at low Sargassum contents.

Variation of the filament's thickness significantly affects the 3D printing process since the filament drive mechanism of the machine is not able to work properly under this condition. SEM analysis also suggests that the composite material is very fluid at 220° C. (temperature used to print all the samples), making it difficult to obtain specimens with well-ordered layered structures. In fact, top-view SEM images of the surface of the 3D printed specimens (not presented here), also indicate that “nozzle dragging” is more severe in samples with higher Sargassum contents. This finding also supports the statement presented above about high flowability of composites with high Sargassumcontents at temperatures ˜220° C.

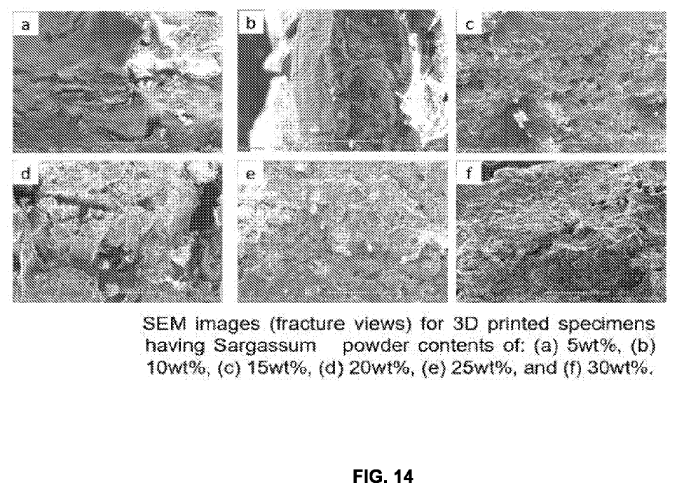

FIG. 14 presents a variety of SEM images corresponding to the surface of specimen's fractures. In this case, it is possible to observe that: (1) the surface roughness increases with the biomass content, and (2) the microstructure changes from a compact to a granular structure (with noticeable particle aggregation) as the biomass content increases from 5 wt % to 30 wt %. In addition, the voids formed at the material surface, because of the Sargassum particle detachment, is a clear indication of the poor compatibility between the Sargassum powder and the PLA polymer matrix.

### viii. Mechanical Characterization of Fabricated Specimens

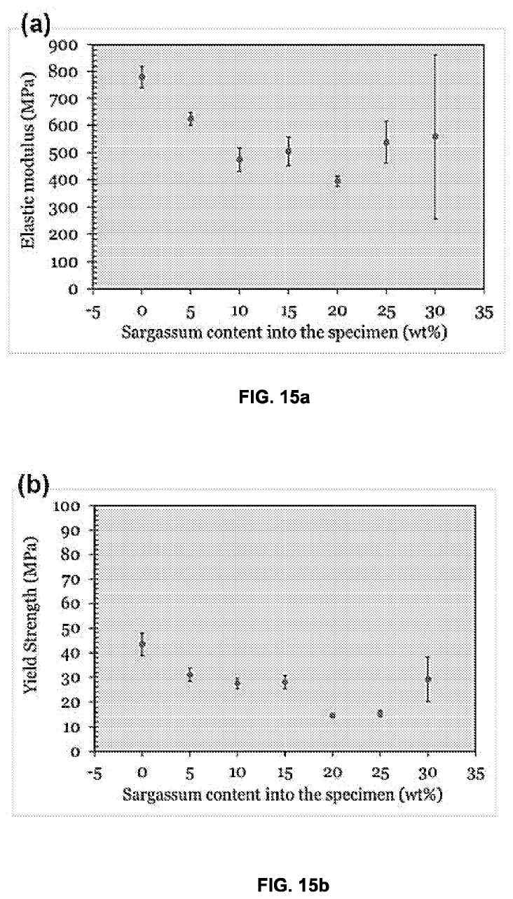

Tensile tests were also performed to evaluate the elastic modulus and yield strength of the fabricated specimens and the results are presented in FIGS. 15a and 15b, respectively. The elastic modulus of the 3D printed specimens exhibit a declining trend as the Sargassum content increases from 0 wt % to 20 wt %. These results are supported by the SEM analysis that shows that the number of defects and surface roughness increases with the biomass content. These defects are usually associated with poor mechanical behaviors, especially in the field of 3D printing of composite materials. In addition, at higher filler contents the variability in the elastic modulus is significant, making it difficult to draw precise conclusions. This variability is supported by the inhomogeneities, and defects observed in the microstructure of specimens with high Sargassum contents. Similarly, yield strength results follow a similar trend. Importantly, to complete this part, the team will be running SEM analysis of PLA specimens.

### ix. Biodegradability Studies

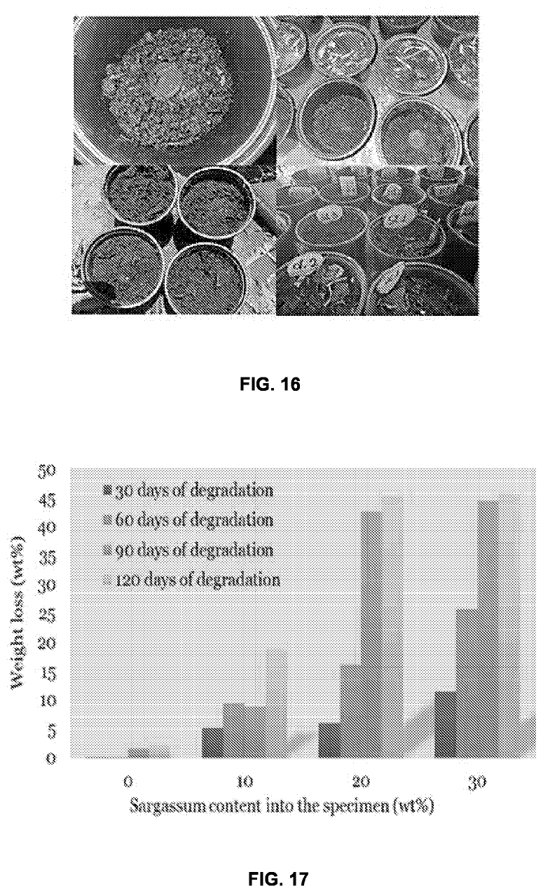

Degradation studies were performed via burial tests as mentioned before. FIG. 16 shows the vases and the coin-shaped object made from varying Sargassum concentrations. After cleaning and drying these samples, these were weighted to calculate the weight loss %. The results of these experiments are summarized in FIG. 17. As expected, the weight loss of the 3D printed specimens increases with the Sargassum content. At higher biomass contents (25-30 wt %), it was possible to observe weight losses up to 45% and most of the losses were registered during the first 90 days. There are many possible reasons to explain this behavior: Firstly, degradation of Sargassum particles increases the surface area of the sample exposed to the compost, which facilitates microbial attack. Secondly, as demonstrated by the SEM analysis of the specimens (FIG. 13), the surface roughness of the 3D printed specimens also increases with the biomass content, facilitating the attachment of the microorganisms to the samples. Finally, it is also possible that the crystallinity of PLA is reduced by the presence of the Sargassum biomass (should be demonstrated by XRD analysis). This fact is important, since in general amorphous materials are less resistant to microbial attack.

Interestingly, the addition of algal biomass is accelerating the degradation of the PLA composite. It is believed that the interaction between the functional groups present on the Sargassumsurface and the PLA, result in the formation of amide and imine functional groups. It is widely known that these types of functional group are preferred by microorganisms, which ultimately led to an easier breakdown of the polymer chains.

### x. Conclusion

Sargassum processed via ball milling exhibited fine particles. However, According to SEM analysis the particle size distribution is very broad (from microns to nanometers). The smaller particle size observed was 50 nm.
Sargassum powder/PLA composite filaments were fabricated via extrusion. The biomass content varied in the range between 0 wt % (pure PLA) to 30 wt %. Importantly, the results suggest the good reprocessability of these novel composites, since the filaments were extruded three times.
Filament thickness variability increased with the biomass content, which had effects on the quality of the 3D printed specimens and their mechanical properties.
The elastic modulus and yield strength of the 3D printed specimens exhibited a declining trend as the Sargassum content into the PLA polymer matrix increased from 0 to 20 wt %. These results are supported by the SEM analysis that shows that the number of defects and surface roughness increases with the biomass content. These defects are usually associated with poor mechanical behaviors.
At higher filler contents the variability in the elastic modulus was significant, making it difficult to draw precise conclusions. This variability is supported by the inhomogeneities, and defects observed in the microstructure of specimens with high Sargassum contents. The yield strength results followed a similar trend.
Burial test results suggest that the weight loss (wt %) of the fabricated specimens increases ˜4.5 times as the biomass content increased from 0 to 30 wt % (after 120 days).

Although certain exemplary embodiments and methods have been described in some detail, for clarity of understanding and by way of example, it will be apparent from the foregoing disclosure to those skilled in the art that variations, modifications, changes, and adaptations of such embodiments and methods may be made without departing from the true spirit and scope of the claims. Therefore, the above description should not be taken as limiting the scope of the invention which is defined by the appended claims.

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means plus function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patently distinguish any amended claims from any applied prior art.

1. A method for making Sargassum-based polymer composite, comprising the steps of:
grinding a predetermined amount of dried Sargassum to obtain Sargassum powder;
pulverizing the Sargassum powder in a ball milling machine to obtain Sargassum nanopowder particles;
wetting an amount of PLA pellets in the range of >0 g to 150 g with an amount of isopropyl alcohol in the range of ˜10-15 mL to obtain a mixture of wet PLA pellets;
mixing an amount of the Sargassum nanopowder particles to the mixture of wet PLA pellets to obtain one or more coated PLA pellets with at least >0 wt % of Sargassum; and
drying the coated PLA pellets.

2. The method of claim 1, further comprising feeding the dried coated PLA pellets into an extruder to obtain one or more Sargassum filaments.

3. The method of claim 1, further comprising the step of drying the Sargassum in an oven at a temperature of at least 120° C. before the step of grinding the Sargassum.

4. The method of claim 3, further comprising the step of rinsing the Sargassum with deionized water before the step of drying of the Sargassum in order to reduce the amounts of sand particles and heavy metals.

5. The method of claim 1, further comprising the step of placing the one or more Sargassum filaments in a 3D printer to fabricate a 3D printing specimen.

6. The method of claim 1, further comprising the step of controlling extrusion temperature and spooling speed to obtain the required filament's thickness and quality.

7. The method of claim 1, wherein the ball milling machine rotates at 600 rpm for at least one hour to pulverize the Sargassum powder.

8. The method of claim 1, wherein the Sargassum nanopowder particles have a smaller particle size of 50 nm.

9. The method of claim 1, wherein, the amount coated PLA pellets are in the range of greater than 0 wt % and less than or equal to 30 wt % Sargassum.

10. A Sargassum-based polymer composite prepared by a process comprising the steps of:
grinding a predetermined amount of dried Sargassum to obtain Sargassum powder;
pulverizing the Sargassum powder in a ball milling machine to obtain Sargassum nanopowder particles;
wetting an amount of PLA pellets in the range of >0 g to 150 g with an amount of isopropyl alcohol in the range of ˜10-15 mL to obtain a mixture of wet PLA pellets;
mixing an amount of the Sargassum nanopowder particles to the mixture of wet PLA pellets to obtain one or more coated PLA pellets with at least >0 wt % of Sargassum; and
drying the coated PLA pellets.

11. The Sargassum-based polymer of claim 10, further comprising feeding the dried coated PLA pellets into an extruder to obtain one or more Sargassum filaments.

12. The Sargassum-based polymer of claim 10, further comprising the step of drying the Sargassum in an oven at a temperature of 120° C. before the step of grinding the Sargassum.

13. The Sargassum-based polymer of claim 10, further comprising the step of rinsing the Sargassum with deionized water before the step of drying of the Sargassum in order to reduce the amounts of sand particles and heavy metals.

14. A Sargassum-based polymer composite comprising:
a thermoplastic; and
a Sargassum nanopowder.

15. The Sargassum-based polymer composite of claim 14, wherein the Sargassum-based polymer composite is a filament for 3D printing.

16. The Sargassum-based polymer composite of claim 14, wherein the Sargassum-based polymer composite is in the range of greater than 0 wt % and less than or equal to 30 wt % Sargassum.

17. The Sargassum-based polymer composite of claim 14, wherein the thermoplastic is selected from the group consisting of: polylactic acid (PLA), acrylonitrile butadiene styrene (ABS), polyamides, polycarbonate (PC), polyvinyl alcohol (PVA), high-impact polystyrene (HIPS), high-density polyethylene (HDPE), polyhydroxyalkanoates (PHA), polybutylene succinate (PBS), and polycaprolactone (PCL).

18. The Sargassum-based polymer composite of claim 15, wherein the Sargassum nanopowder has a smaller particle size of 50 nm.

19. The Sargassum-based polymer composite of claim 15, wherein the Sargassum nanopowder has a biomass content in the range of >0 wt-30 wt %.
